(19) United States
(12) Patent Application Publication
(10) Pub. No.: US 2026/0128396 A1
(43) Pub. Date: May 7, 2026

(54) BATTERY MONITORING MODULE

(71) Applicant: MEKTEC CORPORATION, Tokyo (JP)

(72) Inventors: Shunsuke TOMITA, Tokyo (JP); Tomoki KANAYAMA, Tokyo (JP); Tsukasa WATANABE, Tokyo (JP); Shogo ATARASHI, Tokyo (JP)

(73) Assignee: MEKTEC CORPORATION, Tokyo (JP)

(21) Appl. No.: 19/378,731

(22) Filed: Nov. 4, 2025

(30) Foreign Application Priority Data
Nov. 6, 2024 (JP) 2024-194243

(51) Int. Cl. H01M 10/42

(52) U.S. Cl. CPC H01M 10/425

(57) ABSTRACT

A battery monitoring module includes: a flexible printed circuit board having a main part and a branched part branched from the main part; a bus bar that is connected to wiring provided to the flexible printed circuit board and is welded to an electrode of a cell in the branched part; and a cover that protects the flexible printed circuit board, in which the cover integrally includes a first cover part that covers the main part and a second cover part that covers the branched part, and the second cover part is capable of exposing a region in which the bus bar is arranged, by rotating an end opposite the first cover part side in the second cover part in a direction approaching the first cover part while the first cover part covers the main part.

### CROSS-REFERENCE TO RELATED APPLICATION

This application is based on Japanese Patent Application No. 2024-194243 filed with the Japan Patent Office on Nov. 6, 2024, the entire content of which is hereby incorporated by reference.

### BACKGROUND

### 1. Technical Field

An embodiment of the present disclosure relates to a battery monitoring module.

### 2. Related Art

A battery monitoring module is provided to an on-board battery mounted on an electric vehicle or the like in order to measure the voltage of a plurality of cells constituting the battery. In this battery monitoring module, a flexible printed circuit board (hereinafter, referred to as an “FPC”) is utilized. This FPC has a main part and a branched part branched from the main part. The battery monitoring module includes a bus bar that is connected to wiring provided to the FPC and is welded to an electrode of a cell in the branched part.

In general, a battery monitoring module includes a cover that covers the main part and a cover part that covers the branched part. The former is attached before connecting the bus bar and the electrode and plays a role in protecting the main part of the FPC at the time of welding. The latter is attached after welding and plays a role in preventing a user from touching the electrode.

JP-A-2018-45825 discloses a technology of integrally disposing a cover to cover the main part and a cover part to cover the branched part for the purpose of reducing the number of components. However, this technology is configured that the cover part to cover the branched part opens toward the outer side than a region in which a plurality of cells is arranged. This requires a wide space for performing work such as welding. Therefore, there remains a room for improvement in this known technology.

Such enlargement of a work space can occur not only in a battery monitoring module utilized in an on-board battery but also in battery monitoring modules used in various devices.

### SUMMARY

A battery monitoring module includes: a flexible printed circuit board having a main part and a branched part branched from the main part; a bus bar that is connected to wiring provided to the flexible printed circuit board and is welded to an electrode of a cell in the branched part; and a cover that protects the flexible printed circuit board, in which the cover integrally includes a first cover part that covers the main part and a second cover part that covers the branched part, and the second cover part is capable of exposing a region in which the bus bar is arranged, by rotating an end opposite the first cover part side in the second cover part in a direction approaching the first cover part while the first cover part covers the main part.

### BRIEF DESCRIPTION OF DRAWINGS

FIGS. 1A to 1C are schematic configuration diagrams of members constituting a battery module according to Example 1 of the present disclosure;

FIGS. 2A to 2C are illustrative diagrams of an assembling procedure of the battery module according to Example 1 of the present disclosure;

FIGS. 3A to 3C are schematic configuration diagrams of a cover according to Example 1 of the present disclosure;

FIGS. 4A to 4C are schematic configuration diagrams of a cover according to Example 2 of the present disclosure;

FIGS. 5A and 5B are schematic configuration diagrams of Holding Structure Example 1;

FIGS. 6A and 6B are schematic configuration diagrams of Holding Structure Example 2;

FIGS. 7A to 7C are schematic configuration diagrams of Holding Structure Example 3;

FIGS. 8A to 8C are schematic configuration diagrams of Holding Structure Example 4; and

FIGS. 9A and 9B are schematic configuration diagrams of Holding Structure Example 5.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An object of the present disclosure is to provide a battery monitoring module capable of narrowing a work space.

A battery monitoring module according to an aspect of the present disclosure includes: a flexible printed circuit board having a main part and a branched part branched from the main part; a bus bar that is connected to wiring provided to the flexible printed circuit board and is welded to an electrode of a cell in the branched part; and a cover that protects the flexible printed circuit board, in which the cover integrally includes a first cover part that covers the main part and a second cover part that covers the branched part, and the second cover part is capable of exposing a region in which the bus bar is arranged, by rotating an end opposite the first cover part side in the second cover part in a direction approaching the first cover part while the first cover part covers the main part.

According to this battery monitoring module, the second cover part is put into a state in which an end opposite the first cover part side in the second cover part is rotated in a direction approaching the first cover part, when exposing a region in which the bus bar is arranged. That is, the second cover part is capable of opening toward the inside of the region in which a plurality of cells is arranged. This eliminates the need to widen a space for performing work.

The first cover part and the second cover part may be integrally formed.

This can reduce the number of components.

The battery monitoring module may include a holding structure of holding the second cover part in a state of exposing the region in which the bus bar is arranged.

That is, when the first cover part and the second cover part are integrally formed, the second cover part is sometimes apt to return to the original state due to an elastic restoring force, in response to the rotation of the second cover part. Therefore, by disposing the above-described holding structure, the second cover part can be prevented from closing at the time of performing work such as welding. This can suppress deterioration of workability.

The second cover part may be arranged to each of both sides of the first cover part, and the battery monitoring module may have an engagement structure of allowing ends opposite the first cover part side in the pair of second cover parts to engage with each other.

Accordingly, the pair of second cover parts can be held in a state of exposing the region in which the bus bar is arranged, by allowing the ends of the second cover parts to engage with each other.

The first cover part and the second cover part may be formed by separate members, and the second cover part may be rotatably linked to the first cover part.

This can prevent the second cover part from being apt to return to the original state due to an elastic restoring force, when the second cover part is rotated, as in a case where the first cover part and the second cover part are integrally formed.

It may be configured that the second cover part integrally includes a second cover part body part and a small cover part, and the small cover part is capable of exposing a part of the region in which the bus bar is arranged, by rotating an end opposite the second cover part body part side in the small cover part in a direction approaching the second cover part body part while the second cover part body part covers the region in which the bus bar is arranged.

Accordingly, when only a part of the region in which the bus bar is arranged is desired to be exposed, depending on its use, the part can be exposed by opening only the small cover part without opening the entirety of the second cover part. Further, since the small cover part opens toward the inside of the region in which a plurality of cells is arranged, a work space does not need to be widened.

The second cover part body part and the small cover part may be integrally formed.

This can reduce the number of components.

The battery monitoring module may include a small cover holding structure of holding the small cover part in a state of exposing a part of the region in which the bus bar is arranged.

This can suppress deterioration of workability.

The second cover part body part and the small cover part may be formed by separate members, and the small cover part may be rotatably linked to the second cover part body part.

This can prevent the small cover part from being apt to return to the original state due to an elastic restoring force, in response to rotation of the small cover part.

Note that the above-described configurations can be adopted in combination, if possible.

As described above, a work space can be narrowed according to an embodiment of the present disclosure.

Hereinafter, embodiments for carrying out the technology of this disclosure will be exemplarily described in detail based on Examples with reference to the drawings. However, the scope of the technology of this disclosure is not intended to be limited to the sizes, materials, shapes, relative arrangements, and others of the constituent components described in Examples, unless otherwise specifically described.

### Example 1

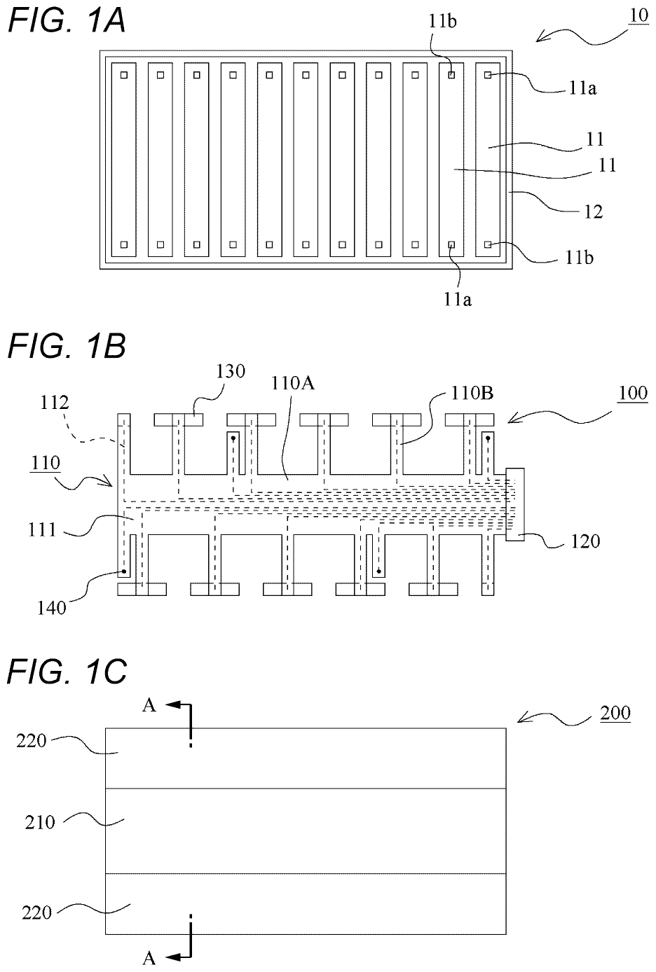

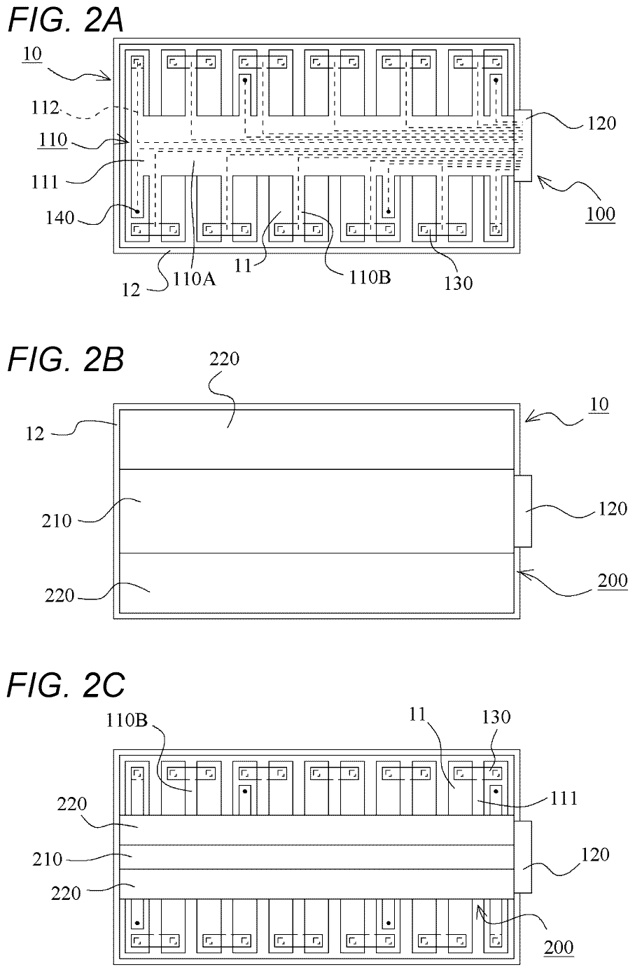

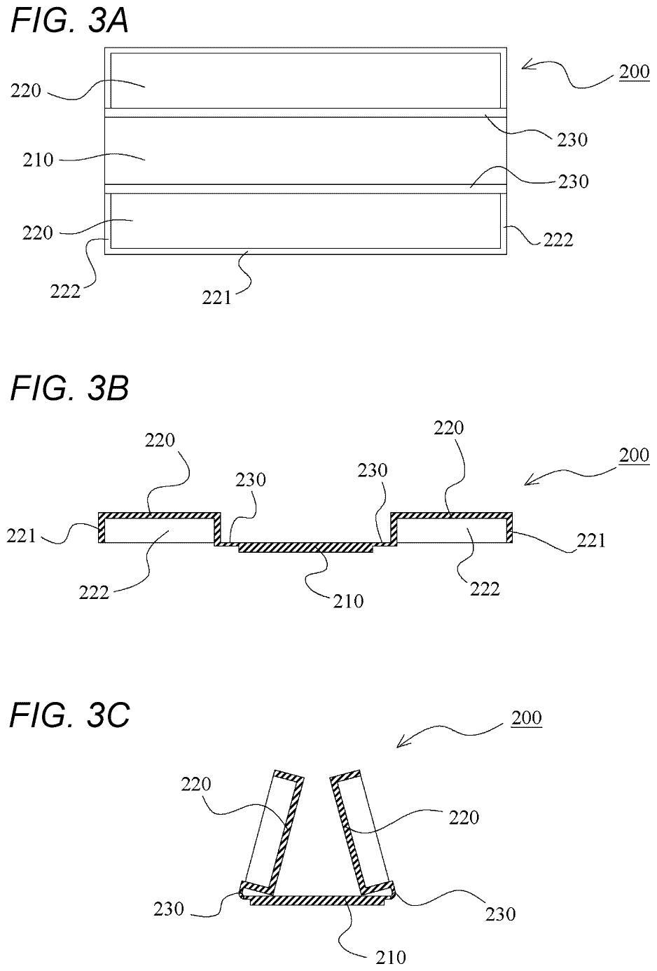

A battery monitoring module according to Example 1 of the present disclosure will be described with reference to FIG. 1A to FIG. 3C. FIGS. 1A to 1C are schematic configuration diagrams of members constituting a battery module according to Example 1 of the present disclosure. FIG. 1A is a plan view of cells arranged in a battery outer case. FIG. 1B is a plan view of a flexible printed circuit board (hereinafter, referred to as an “FPC”). FIG. 1C is a plan view of a cover. FIGS. 2A to 2C are illustrative diagrams of an assembling procedure of the battery module according to Example 1 of the present disclosure. FIG. 2A is a plan view of the battery module in a state in which the FPC is attached in the battery outer case. FIG. 2B is a plan view of the battery module in a state in which the cover is attached in the battery outer case. FIG. 2C is a plan view of the battery module in a state in which a second cover part is opened for performing welding work. FIGS. 3A to 3C are schematic configuration diagrams of the cover according to Example 1 of the present disclosure. FIG. 3A is a back surface view of the cover. FIG. 3B is a cross-sectional view of the cover (AA cross-sectional view in FIG. 1C). FIG. 3C is a cross-sectional view of the cover in a state in which the second cover part is opened.

### Battery Module

The battery module according to the present example will be particularly described with reference to FIGS. 1A to 1C. The battery module includes a battery 10 having a plurality of cells 11 and a battery monitoring module that is attached to the battery 10 and measures the voltage and temperature of the plurality of cells 11.

The battery 10 includes, as illustrated in FIG. 1A, the plurality of cells 11 and a battery outer case 12 in which the plurality of cells 11 is housed. The plurality of cells 11 is arranged such that positive electrodes 11a and negative electrodes 11b are next to each other. Further, the neighboring positive electrodes 11a and negative electrodes 11b are electrically connected by bus bars 130 provided to the battery monitoring module such that the plurality of cells 11 is connected in series. Note that in the illustrated example, the battery 10 including eleven cells 11 is illustrated for convenience of explanation. However, a battery mounted on an electric vehicle or the like is generally constituted by more cells.

As illustrated in FIGS. 1B and 1C, a battery monitoring module 100 includes an FPC 110, a connector 120 attached to the tip of the FPC 110, a bus bar 130 weld-fixed to an electrode (a positive electrode 11a or a negative electrode 11b) of a cell 11, and a cover 200 that protects the FPC 110. The connector 120 is connected to a measuring device (not illustrated) that measures the voltage and temperature of the cell 11 constituting the battery 10 and performs various controls.

Since the FPC 110 itself is a known technology, detailed description thereof will be omitted, and the structure will be simply described. The FPC 110 includes a base film 111, wiring 112 that is disposed on a surface of the base film 111 and formed of copper foil or the like, and a cover film that protects the wiring 112. In the drawings, the wiring 112 is appropriately illustrated in perspective. Examples of the FPC applicable to Examples of the present disclosure include a single-sided FPC in which wiring and a cover film are disposed to only a single side of a base film, a both-sided FPC in which wiring and a cover film are disposed to both sides of a base film, and an FPC having a structure of more layers. The FPC 110 according to the present example has a main part 110A and a branched part 110B branched from the main part 110A. The FPC 110 includes a plurality of the branched parts 110B. In the branched part 110B, the bus bar 130 is connected to the wiring 112 provided to the FPC 110. Further, a thermistor 140 to measure the temperature of the cell 11 is attached to the FPC 110.

### Assembling Procedure of Battery Module

The assembling procedure of the battery module according to the present example will be particularly described with reference to FIGS. 2A to 2C. First, a plurality of cells 11 is disposed in a battery outer case 12 (see FIG. 1A). Note that although a diaphragm or the like is generally disposed between the neighboring cells 11, description thereof will be omitted herein. Next, an FPC 110 previously attached with a connector 120 and a bus bar 130 is attached to the top of a battery 10 including the plurality of cells 11 (see FIG. 2A). Note that in general, the FPC 110 is attached, together with a case that supports the FPC 110, to the top of a battery in a state in which the FPC 110 is attached to the case. In the present example, description of the case will be omitted because it is a known technology. For facilitating the understanding of the configuration of each component, the case is also omitted in each drawing.

After the FPC 110 has been attached in the battery outer case 12, a cover 200 is attached. Note that FIG. 2B is a view of the battery module in a state before the cover 200 is attached and before welding work is performed, and the battery module in a state after welding work ended and after the cover 200 was completely closed. FIG. 2C is a view of the battery module when welding work is performed.

### Cover

The cover 200 will be described in more detail. The cover 200 integrally includes a first cover part 210 that covers the main part 110A and a second cover part 220 that covers the branched part 110B. The second cover part 220 is disposed to each of both sides of the first cover part 210. The first cover part 210 and the second cover part 220 are linked through a thin-walled part 230 (see FIGS. 3A to 3C). This thin-walled part 230 exerts a function as a hinge for allowing the second cover part 220 to be rotatable with respect to the first cover part 210. Accordingly, the second cover part 220 is capable of exposing a region in which the bus bar 130 is arranged by rotating an end (corresponding to the upper or lower end in FIG. 2B and FIG. 3A as well as the left or right end in FIG. 3B) opposite the first cover part 210 side in a direction approaching the first cover part 210 while the first cover part 210 covers the main part 110A (see FIG. 2C and FIG. 3C). Note that FIG. 3C is a view of the AA cross section in FIG. 1C in a state in which the pair of second cover parts 220 is opened. As illustrated in FIG. 3B, the second cover part 220 on the left rotates around the thin-walled part 230 in the clockwise direction in the drawing. On the other hand, the second cover part 220 on the right rotates around the thin-walled part 230 in the counterclockwise direction in the drawing.

The cover 200 according to the present example is a resin molded product and can be obtained by molding. The first cover part 210, the second cover part 220, and the thin-walled part 230 are integrally formed. That is, the cover 200 is formed as one member.

The first cover part 210 is constituted by a flat plate-like portion. The second cover part 220 includes a first side wall part 221 and a second side wall part 222 each to serve as a diaphragm between the connecting part between the electrode of the cell 11 and the bus bar 130, and the battery outer case 12.

According to the cover 200 configured as described above, welding work between the electrode (the positive electrode 11a or the negative electrode 11b) of the cell 11 and the bus bar 130 can be performed in a state in which the second cover part 220 is opened as illustrated in FIG. 2C and FIG. 3C. Then, a user can be prevented from touching the electrode by closing the second cover part 220 after welding work as illustrated in FIG. 2B.

### Advantages of Battery Monitoring Module According to Present Example

In the present example, the second cover part 220 is capable of exposing a region in which the bus bar 130 is arranged, by rotating an end opposite the first cover part 210 side in the second cover part 220 in a direction approaching the first cover part 210 while the first cover part 210 covers the main part 110A. Therefore, the second cover part 220 is put into a state in which the end opposite the first cover part 210 side in the second cover part 220 is rotated in a direction approaching the first cover part 210, when exposing the region in which the bus bar 130 is arranged. That is, the second cover part 220 is configured to open toward the inside of the region in which the plurality of cells 11 is arranged. This eliminates the need to widen a space for performing welding work. Note that while welding work is performed, the main part 110A is protected by the first cover part 210. This suppresses damage of the main part 110A attributable to welding work.

Further, since the first cover part 210 and the second cover part 220 are integrally formed in the present example, the number of components can be reduced.

### Example 2

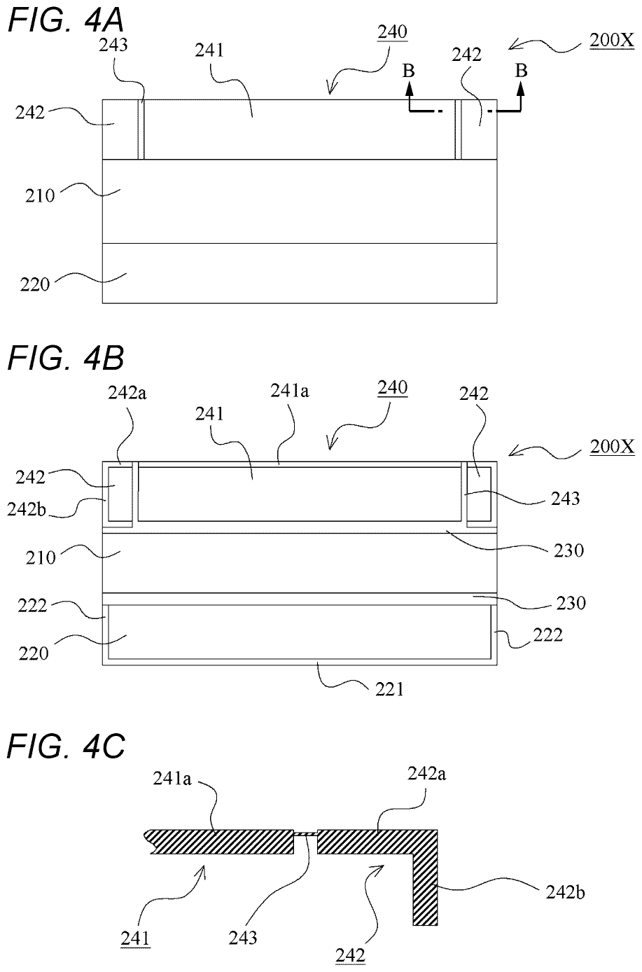

FIGS. 4A to 4C are views of Example 2 of the present disclosure. In the present example, the configuration of the second cover part is different from that in Example 1. Since the fundamental configuration and operation of Example 2 are the same as those in Example 1, description of the same constituent portion will be appropriately omitted with the same reference numeral assigned.

Since configurations (the battery, the FPC and the like) other than the cover are as described in Example 1, description thereof will be omitted. FIGS. 4A to 4C are schematic configuration diagrams of the cover according to Example 2 of the present disclosure. FIG. 4A is a plan view of the cover. FIG. 4B is a back surface view of the cover. FIG. 4C is a cross-sectional view of the cover (BB cross-sectional view in FIG. 4A, without the depth line).

A cover 200X according to the present example integrally includes a first cover part 210 that covers the main part and a second cover part 220, 240 that covers the branched part. The first cover part 210 and the second cover part 220, 240 are linked through a thin-walled part 230. This thin-walled part 230 exerts a function as a hinge for allowing the second cover part 220, 240 to be rotatable with respect to the first cover part 210. Accordingly, the second cover part 220, 240 is capable of exposing a region in which the bus bar is arranged, by rotating an end opposite the first cover part 210 side in the second cover part 220, 240 in a direction approaching the first cover part 210 while the first cover part 210 covers the main part, similarly to Example 1.

The cover 200X according to the present example is also a resin molded product and can be obtained by molding. The first cover part 210, the second cover part 220, 240, and the thin-walled part 230 are integrally formed. That is, the cover 200X is formed as one member.

The first cover part 210 is constituted by a flat plate-like portion. The configuration of the second cover part 220 is the same as that in Example 1. The second cover part 240 according to the present example integrally includes a second cover part body part 241 and a small cover part 242. This small cover part 242 is capable of exposing a part of the region in which the bus bar is arranged by rotating an end (corresponding to the left or right end in FIGS. 4A and 4B) opposite the second cover part body part 241 side in the small cover part 242 in a direction approaching the second cover part body part 241 while the second cover part body part 241 covers a region in which the bus bar is arranged. The second cover part body part 241 and the small cover part 242 are linked through a thin-walled part 243. This thin-walled part 243 exerts a function as a hinge for allowing the small cover part 242 to be rotatable with respect to the second cover part body part 241. Accordingly, the small cover part 242 is capable of exposing a part of the region in which the bus bar is arranged, by rotating an end opposite the second cover part body part 241 side in the small cover part 242 in a direction approaching the second cover part body part 241 while the second cover part body part 241 covers the region in which the bus bar is arranged. Note that in FIG. 4C, a part of the region in which the bus bar is arranged is exposed by rotating the small cover part 242 around the thin-walled part 243 in the counterclockwise direction in the drawing. In the present example, the second cover part 240 is configured that the rotation center axis of the second cover part 240 and the rotation center axis of the small cover part 242 are orthogonal to each other.

The second cover part body part 241 includes a side wall part 241a to serve as a diaphragm between the connecting part between the electrode of the cell and the bus bar, and the battery outer case. The small cover part 242 includes a first side wall part 242a and a second side wall part 242b each to serve as a diaphragm between the connecting part between the electrode of the cell and the bus bar, and the battery outer case.

Note that in the present example, the second cover part body part 241 and the small cover part 242 are integrally formed.

According to the cover 200X configured as described above, the same effect as that in Example 1 can be obtained.

Further, in the present example in which the small cover part 242 is disposed, it is possible to expose only a part of the region in which the bus bar is arranged, by opening only the small cover part without opening the entirety of the second cover part, when it is desired depending on its use. For example, at the time of connecting the cell and electrical wiring (wiring such as an electrical harness) separately from the FPC, the small cover part 242 may be disposed at both longitudinal ends of the second cover part body part 241 as illustrated. Since the small cover part 242 is configured to open toward the inside of the region in which a plurality of cells is arranged, a work space does not need to be widened.

### Holding Structure

In the above-described Examples, the first cover part 210 and the second cover part 220, 240 are integrally formed. In this case, the second cover part 220, 240 is sometimes apt to return to the original state due to an elastic restoring force, in response to the rotation of the second cover part 220, 240. Therefore, it is preferable to take such a measure to prevent the second cover part 220, 240 from closing while work such as welding is performed. For example, the second cover part 220, 240 can be temporarily fixed with a tape or using a certain member. However, this requires separately using a dedicated member for fixing. Further, it is conceivable to thin the thin-walled part 230, if possible, to reduce rigidity so as to extremely reduce an elastic restoring force. However, this causes a decrease in strength of the thin-walled part 230, so that the thin-walled part 230 may be ruptured. Such a concern also occurs in the relationship between the second cover part body part 241 and the small cover part 242 in Example 2.

Therefore, it is desirable that the battery monitoring module 100 includes a holding structure of holding the second cover part in a state of exposing the region in which the bus bar is arranged. Further, it is desirable that in the configuration of Example 2, the battery monitoring module 100 includes a small cover holding structure of holding the small cover part 242 in a state of exposing a part of the region in which the bus bar is arranged. For these holding structures, an example of the structure applicable to the both and an example of the structure applicable to the former will be described below.

### Holding Structure Example 1

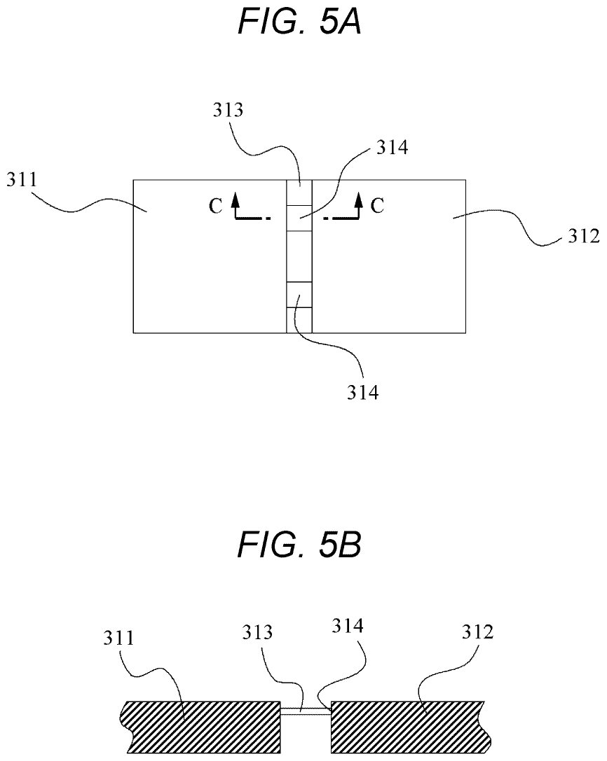

FIGS. 5A and 5B are schematic configuration diagrams of Holding structure Example 1. FIG. 5A is a plan view of the holding structure. FIG. 5B is a cross-sectional view of the holding structure (CC cross-sectional view in FIG. 5A, without the depth line). This holding structure includes a first portion 311, a second portion 312, and a thin-walled part 313 linking the first portion 311 and the second portion 312. For example, the first cover part 210 in Example 1 corresponds to the first portion 311, the second cover part 220 corresponds to the second portion 312, and the thin-walled part 230 corresponds to the thin-walled part 313. Further, the second cover part body part 241 in Example 2 corresponds to the first portion 311, the small cover part 242 corresponds to the second portion 312, and the thin-walled part 243 corresponds to the thin-walled part 313.

This structure example is different from the configurations in Examples 1 and 2, in that the thin-walled part 313 is disposed at a plurality of locations, and a through hole 314 is disposed between the neighboring thin-walled parts 313. According to this structure example, it is possible to reduce the rigidity of a portion functioning as a hinge of the thin-walled part 313 without excessively thinning the thickness itself of the thin-walled part 313. This can reduce the elastic restoring force of the thin-walled part 313. This can prevent the second portion 312 from returning to the original state due to an elastic restoring force even when the second portion 312 is rotated (rotated in the counterclockwise direction in FIG. 5B) around the thin-walled part 313 with respect to the first portion 311.

### Holding Structure Example 2

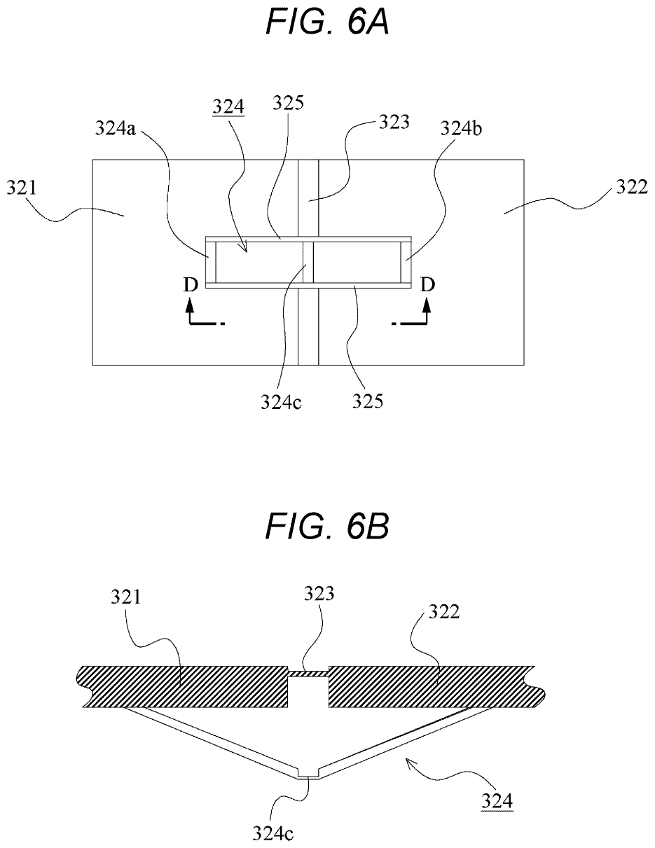

FIGS. 6A and 6B are schematic configuration diagrams of Holding structure Example 2. FIG. 6A is a plan view of the holding structure. FIG. 6B is a cross-sectional view of the holding structure (DD cross-sectional view in FIG. 6A, without a part of the depth line). This holding structure includes a first portion 321, a second portion 322, and a thin-walled part 323 linking the first portion 321 and the second portion 322. For example, the first cover part 210 in Example 1 corresponds to the first portion 321, the second cover part 220 corresponds to the second portion 322, and the thin-walled part 230 corresponds to the thin-walled part 323. Further, the second cover part body part 241 in Example 2 corresponds to the first portion 321, the small cover part 242 corresponds to the second portion 322, and the thin-walled part 243 corresponds to the thin-walled part 323.

In this structure example, a three-point hinge part 324 is disposed separately from the thin-walled part 323 having a hinge function. This three-point hinge part 324 is configured to be capable of acting without the interference by the first portion 321 and the second portion 322, by slits 325 disposed at both sides thereof. Further, the three-point hinge part 324 is configured to be bent downward with respect to the first portion 321 and the second portion 322 as illustrated in FIG. 6B in an initial state in which an external force does not act on the holding structure. Further, the three-point hinge part 324 is linked to the first portion 321 and the second portion 322 by thin-walled parts 324a and 324b, respectively. Further, a thin-walled part 324c is disposed to the center of the three-point hinge part 324.

According to the structure example configured as described above, it is possible to hold the second portion 322 (to maintain the position of the second portion 322) by the function of the three-point hinge part 324, by rotating the second portion 322 (in the counterclockwise direction in FIG. 6B) around the thin-walled part 323 with respect to the first portion 321 such that the second portion 322 is positioned at a prescribed position.

### Holding Structure Example 3

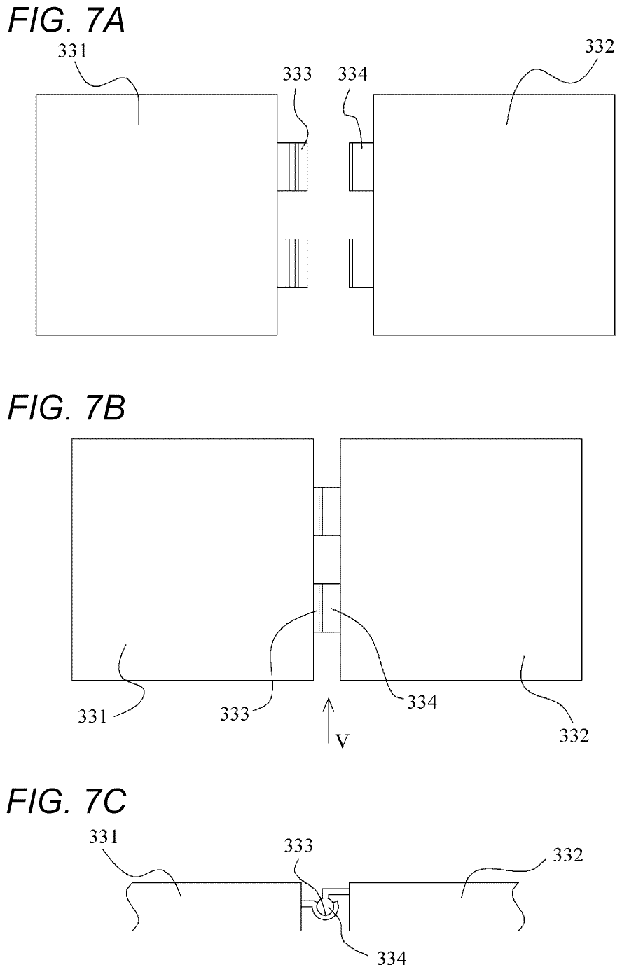

FIGS. 7A to 7C are schematic configuration diagrams of Holding structure Example 3. FIGS. 7A and 7B are plan views of the holding structure. FIG. 7A is a view of two members before linked. FIG. 7B is a view of two members after linked. FIG. 7C is a side view (a view seen in the V direction in FIG. 7B) of the holding structure. This holding structure includes a first portion 331 and a second portion 332. In this holding structure, the first portion 331 and the second portion 332 are formed by separate members, which is different from in Examples and Holding Structure Examples described above. For example, the first cover part 210 in Example 1 corresponds to the first portion 331, and the second cover part 220 corresponds to the second portion 332. Further, the second cover part body part 241 in Example 2 corresponds to the first portion 331, and the small cover part 242 corresponds to the second portion 332.

An engaged part 333 having an arc-shaped groove when seen from the side is disposed to the first portion 331. Further, an engaging part 334 having an arc-shaped projection when seen from the side is disposed to the second portion 332. Accordingly, it is possible to fit the projection of the engaging part 334 into the groove of the engaged part 333 such that the second portion 332 can be rotatably (within a certain range) linked to the first portion 331.

According to the structure example configured as described above, the first portion 331 and the second portion 332 are formed by separate members. Therefore, even when the second portion 332 is rotated (rotated in the counterclockwise direction in FIG. 7C) with respect to the first portion 331, an elastic restoring force does not occur. Therefore, the second portion 322 can be held in a state of setting the position of the second portion 332 with respect to the first portion 331 to an optional position, by setting a frictional force between the projection of the engaging part 334 and the groove of the engaged part 333 to an appropriate force.

### Holding Structure Example 4

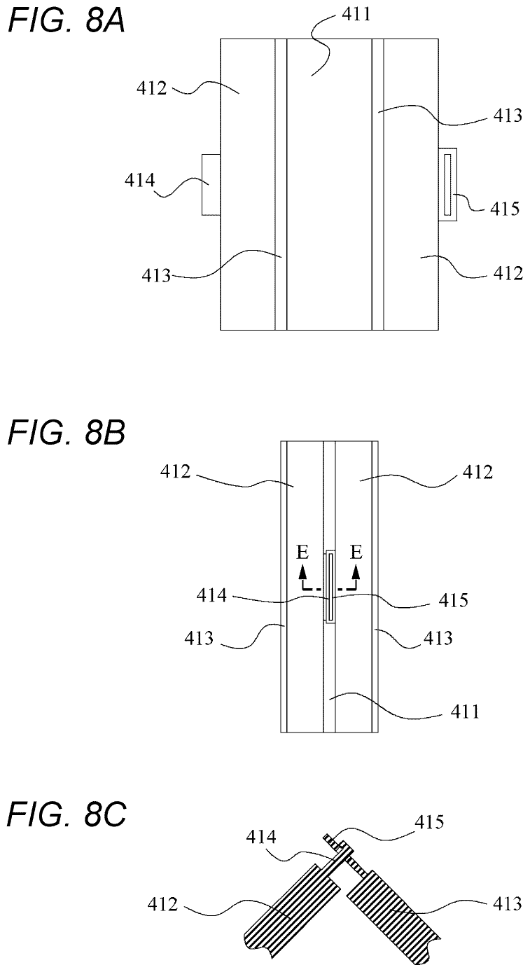

FIGS. 8A to 8C are schematic configuration diagrams of Holding structure Example 4. FIGS. 8A and 8B are plan views of the holding structure. FIG. 8A is a view of a state before holding. FIG. 8B is a view of a holding state. FIG. 8C is a cross-sectional view of the holding structure (EE cross-sectional view in FIG. 8B, without the depth line). This holding structure includes a first portion 411, a second portion 412, and a thin-walled part 413 linking the first portion 411 and the second portion 412. For example, the first cover part 210 in Example 1 corresponds to the first portion 411, the second cover part 220 corresponds to the second portion 412, and the thin-walled part 230 corresponds to the thin-walled part 413.

The second portion 412 is arranged to each of both sides of the first portion 411. In this holding structure, the battery monitoring module 100 has an engagement structure of allowing the ends (the left and right ends in FIG. 8A) opposite the first portion 411 side in the pair of second portions 412 to engage with each other. Specifically, an engaging part 414 having a projection is disposed to the end of the second portion 412 on the left in FIG. 8A. Further, an engaged part 415 having an engaging hole is disposed to the end of the second portion 412 on the right.

In the above-described configuration, the second portion 412 on the left in FIG. 8A is rotated (rotated in the clockwise direction in FIG. 8C) around the thin-walled part 413 with respect to the first portion 411, and the second portion 412 on the right in FIG. 8A is rotated (rotated in the counterclockwise direction in FIG. 8C) around the thin-walled part 413 with respect to the first portion 411. Then, the projection of the engaging part 414 is allowed to engage with the engaging hole of the engaged part 415, so that the pair of second portions 412 can be held.

### Holding Structure Example 5

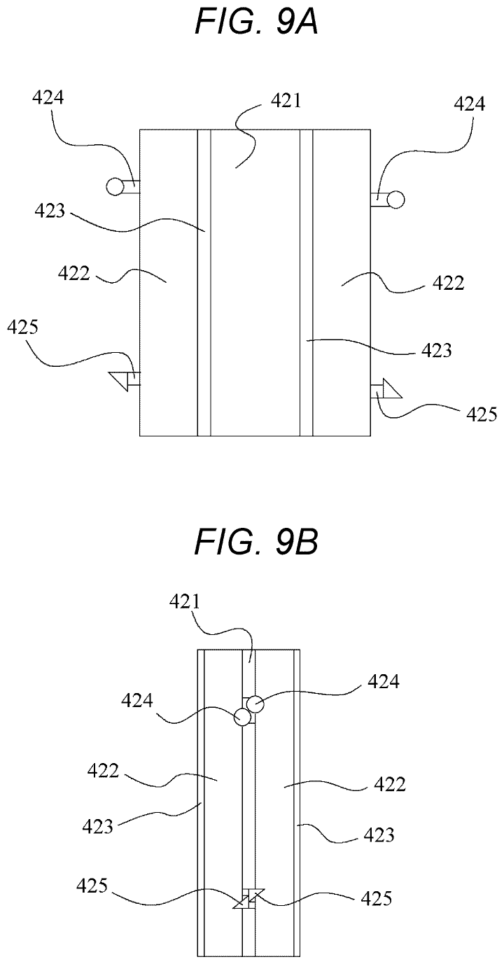

FIGS. 9A and 9B are schematic configuration diagrams of Holding structure Example 5 and are plan views of the holding structure. FIG. 9A is a view of a state before holding, and FIG. 9B is view of a holding state. This holding structure includes a first portion 421, a second portion 422, and a thin-walled part 423 linking the first portion 421 and the second portion 422. For example, the first cover part 210 in Example 1 corresponds to the first portion 421, the second cover part 220 corresponds to the second portion 422, and the thin-walled part 230 corresponds to the thin-walled part 423.

The second portion 422 is arranged to each of both sides of the first portion 421. In this holding structure, the battery monitoring module 100 has an engagement structure of allowing the ends (the left and right ends in FIG. 9A) opposite the first portion 421 side in the pair of second portions 422 to engage with each other. Specifically, engaging parts 424 and 425 each having a projection is disposed to the ends of the pair of second portions 422.

In the above-described configuration, the pair of second portions 422 can be held by rotating (rotating toward the front side in the paper in FIGS. 9A and 9B) the pair of second portions 422 around the thin-walled part 423 with respect to the first portion 421 and allowing the projections of the engaging parts 424 to engage with each other and the projections of the engaging parts 425 to engage with each other.

Note that the projection of the engaging part 424 has a spherical shape, and the projection of the engaging part 425 has a triangular prism shape. That is, in the illustrated configuration example, the engaging parts 424 and 425 having differently shaped projections are provided at two locations. Regarding this, it is needless to say that the engaging parts having identically shaped projections may be disposed at a plurality of locations. The shape of the projection is not limited to the illustrated shape, as long as it allows for engagement. It is also needless to say that the number of engaging parts is not limited.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A battery monitoring module comprising:
a flexible printed circuit board having a main part and a branched part branched from the main part;
a bus bar that is connected to wiring provided to the flexible printed circuit board and is welded to an electrode of a cell in the branched part; and
a cover that protects the flexible printed circuit board, wherein
the cover integrally includes a first cover part that covers the main part and a second cover part that covers the branched part, and
the second cover part is capable of exposing a region in which the bus bar is arranged, by rotating an end opposite the first cover part side in the second cover part in a direction approaching the first cover part while the first cover part covers the main part.

2. The battery monitoring module according to claim 1,
wherein the first cover part and the second cover part are integrally formed.

3. The battery monitoring module according to claim 2, further comprising
a holding structure of holding the second cover part in a state of exposing the region in which the bus bar is arranged.

4. The battery monitoring module according to claim 3, wherein
the second cover part is arranged to each of both sides of the first cover part, and
the battery monitoring module has an engagement structure of allowing ends opposite the first cover part side in a pair of the second cover parts to engage with each other.

5. The battery monitoring module according to claim 1,
wherein the first cover part and the second cover part are formed by separate members, and the second cover part is rotatably linked to the first cover part.

6. The battery monitoring module according to claim 1, wherein
the second cover part integrally includes a second cover part body part and a small cover part, and
the small cover part is capable of exposing a part of the region in which the bus bar is arranged, by rotating an end opposite the second cover part body part side in the small cover part in a direction approaching the second cover part body part while the second cover part body part covers the region in which the bus bar is arranged.

7. The battery monitoring module according to claim 6,
wherein the second cover part body part and the small cover part are integrally formed.

8. The battery monitoring module according to claim 7, further comprising
a small cover holding structure of holding the small cover part in a state of exposing a part of the region in which the bus bar is arranged.

9. The battery monitoring module according to claim 6,
wherein the second cover part body part and the small cover part are formed by separate members, and the small cover part is rotatably linked to the second cover part body part.
